(19) United States
(12) Patent Application Publication
(10) Pub. No.: US 2022/0390588 A1
(43) Pub. Date: Dec. 8, 2022

(54) RADAR AND LIDAR COMBINED MAPPING SYSTEM

(71) Applicant: OUTSIGHT, Paris (FR)

(72) Inventor: Raul BRAVO ORELLANA, Paris (FR)

(21) Appl. No.: 17/775,153

(22) PCT Filed: Nov. 6, 2020
(86) PCT No.: PCT/EP2020/081376

§ 371 Date: May 6, 2022

(30) Foreign Application Priority Data
Nov. 8, 2019 (EP) 19306454.0

(51) Int. Cl. G01S 13/86; G01S 13/89; G01S 17/89; G01S 13/931; G01S 17/931

(52) U.S. Cl. CPC G01S 13/865; G01S 13/89; G01S 13/867; G01S 17/89; G01S 13/931; G01S 17/931

(57) ABSTRACT

A system including a radar configured to generate at least a first frame including a first point cloud and first relative speeds, an imager such as a Lidar configured to generate at least a second frame formed as an image and including a second point cloud and second relative speeds, at least a clock configured to generate first and second timestamps associated to the first frame and second frame respectively, a memory configured to store a map, a computing unit configured to update the map with a registration of the first point cloud data of the first frame using the first timestamp and the first relative speeds, and further configured to update the map with a registration of the second point cloud data of the second frame using the second timestamp and the relative speeds associated with the second frame. Map building method carried out in such a system.

### FIELD OF THE DISCLOSURE

Systems and methods for dynamically generating and updating a tridimensional map of an environment surrounding an entity, like a vehicle or another mobile entity, are described herein, along with systems and methods for simultaneous localization and mapping (‘SLAM’ in short).

The disclosure concerns notably the systems and processes to generate and update a rolling tridimensional map for moving vehicles specially autonomous-driving, self-driving or semi-autonomous vehicles. This disclosure also relates to an automotive vehicle equipped with such a system.

It is however also possible to use the promoted solution in the frame of monitoring systems for surveillance of protected volumes by fixed scanners.

### BACKGROUND OF THE DISCLOSURE

The present application belongs the field of the generation of tridimensional environment maps that are representative of the surroundings of one or several moving objects and vehicles. These maps are dynamically generated and updated using tridimensional sensors/scanners mounted on said vehicles. These maps can be called ‘floating’ maps or otherwise ‘rolling’ maps, since they are built incrementally along the vehicle travel (i.e. the map has a moving footprint).

A tridimensional scanner (or imager) acquires sets of data points, called point clouds, that are representative of the objects located in a local volume of the environment surrounding said scanner/imager, also called a ‘scene’. One example of a commonly used tridimensional scanner is a laser rangefinder such as a light detection and ranging (LIDAR) module which periodically scans its environment using a rotating laser beam. Some special Lidars are able to acquire their environment from a common simultaneous illumination, they are known as flash lidars. Also, one can use one or more video camera(s), either with a plurality of 2D camera and/or one or more TOF 3D camera.

The acquired point clouds can be used to generate 3D maps of the environment seen by the vehicles during a travel for mapping purposes. The 3D maps may also be used to assist or to automate the driving of the vehicles, in particular for so-called autonomous vehicles.

However, combining point clouds generated by separated tridimensional scanners/imagers is a non-trivial procedure as the raw data generated by each tridimensional scanner/imager is sparse, noisy and discretized.

Besides, according to EP3525000, it is necessary to provide a precise and accurate positions of the camera and lidar device(s), in order to carry out registration.

Therefore, the inventors have endeavored to propose an improved solution to reliably build a rolling (moving footprint) tridimensional map of an environment surrounding a vehicle and to reliably detect and identify objects, fixed or moving located in the environment surrounding a vehicle.

Besides, in the present document, we may use indifferently the terms “speed” and “velocity” to designate the same item.

### SUMMARY OF THE DISCLOSURE

According to one aspect of the present disclosure, it is disclosed a system comprising
a radar configured to generate at least a first frame comprising a first point cloud and first relative speeds,
an imager configured to generate at least a second frame formed as an image and comprising a second point cloud and second relative speeds,
at least a clock configured to generate first and second timestamps associated to the first and second frame respectively,
a memory configured to store a map (1),
a computing unit (6) configured to update the map with a registration of the first point cloud data of the first frame using the first timestamp and the first relative speeds, speed data being used to register a newly received first frame, and further configured to update the map with a registration of the second point cloud data of the second frame using the second timestamp and the second relative speeds, speed data being used to register a newly received second frame.

The term “map” should be understood as a “rolling map of the scene” means here map which is built incrementally along the travel of the radar and imager units when they move together with a vehicle. In this sense, “rolling map” may otherwise be called ‘floating map’ or ‘incremental map’, the overall footprint of the map moves along generally with the vehicle. Whenever the radar and imager units are in a stationary configuration, we may still use in the present disclosure the term of rolling map.

We note that the “scene” of interest can be also moving along with the vehicle of interest. Areas of interest are situated ahead and aside the vehicle of interest, without excluding backside.

The term “imager” refers to a Lidar system or to a 3D camera/video system.

Thanks to the above arrangement, the buildup process of the map of the scene benefits from strengths of respective radar and lidar/video units, namely respectively velocity/speed accuracy on radar side and position accuracy on lidar/video imager side. Said otherwise, on one side precision and resolution of lidar/video is advantageously combined, on the other side, with low-level velocity accurate detection of radar; and this combination turns out to substantially enhance the overall accuracy and reliability of the map of the scene.

Also adverse climatic conditions do not affect the same way the radar and imager units. For example, presence of fog degrades Lidar but not much radar, whereas electromagnetic interference may affect radar operation but not lidar/3D video. This redundancy improves overall service and dependability.

Also the radar units and lidar units do not react the same regarding some particular materials like transparent materials, stealth materials; combining the two approaches enhances the overall result. Moving objects can be tracked more easily since entities present within the scene are tracked by their position and their speed. It is to be noted that the proposed method and system can also be beneficial even though there is no moving object in the scene but the vehicle and its radar and imager units are moving.

The term “registration process” shall be construed as the process to cause the point cloud frame of interest (the latest received) to find the best possible match into the rolling 3D map of the scene, which implies mathematical transformation(s) to shift, orientate, spread-in spread-out the array of points of the point cloud frame of interest.

It should be noted that the point cloud frames from the radar unit are registered independently from the registration of the point cloud frames from the imager unit, and vice versa.

The radar and imager units may be called ‘scanners’ in the present document.

By ‘asynchronously’, it is meant that since the radar and imager units operate independently, the first and second point cloud frames (11,12) are received asynchronously, i.e. without any common timing, or stated otherwise each frame of each scanner can arrive at different moments.

Regarding the term “relative speed”, this “relative speed” includes a radial relative speed relative to the radar unit (respectively imager unit). Notably, the radar unit can directly measure the radial relative speed. We note that the radar unit exhibits a good accuracy regarding speed determination, notably radial relative velocity. Here the term “radial”, qualifying the relative speed, means a speed vector projected on a radius line extending between the sensing device and the target point.

But the “relative speed” can also include more information, namely tangential speed in one or two direction (e.g. horizontal and vertical).

In practice, there may be a small or large overlap between a newly received frame and the rolling 3D map, and this is enough to allow reliable registration and then incrementing the content of the rolling 3D map.

It should be noted that the first radar-type scanner unit can be a 3D scanner or can be otherwise a 2D scanner (for example azimuthal horizontal scanning with large vertical aperture), the latter can be a cost-effective solution to provide velocity data about the most interesting points in the rolling 3D map.

The term “radar-type scanner” shall be construed as a scanner using bursts of electromagnetic waves and echoes on objects therefrom, said electromagnetic waves having a carrier frequency comprised between 10 MHz and 100 GHz.

The term “lidar-type scanner” shall be construed as a scanner using bursts of electromagnetic waves and echoes backscattering on objects therefrom, said electromagnetic waves being generally in the near infra-red domain, for example having a wavelength comprised between 600 nanometer and 2000 nanometer, more preferably in the range 1400-1600 nm, and in a particular embodiment about 1550 nanometer.

Unlike some known systems, speed data (e.g. at least relative radial speed) is used to register a newly received frame into the current rolling map of the scene. The matching process can primarily use the speed data to search for substantial coincidence regarding the speed of points (newly received frame versus rolling 3D map). In other words, fusion for registration is made through velocity vector (proximity rule like least squares approach or similar, or likewise any ICP algorithm).

Practically, speed data can provide advantageously supplemental information with regard to position data. Moving objects can be more reliably detected and tracked since their velocity is different from the other items in the background. Preferably speed-based registration can be performed together with position-based registration; though it is not excluded to perform speed-based registration alone.

We note here that the knowledge of relative positions of the radar unit and the imager unit is not necessary. Registration and determination of matrix transformation do not require to know the shift and rotate arguments and/or a predetermined transformation matrix.

In various embodiments, one may possibly have recourse in addition to one and/or other of the following arrangements, taken alone or in combination.

According to one aspect, the imager comprises a lidar-type sensing unit. This is a solution which can work with dark conditions and/or at night, with medium or high spatial resolution. Further, lidar devices are less sensitive to EMC jamming.

According to one aspect, the imager comprises a stereo-imaging device, such as a 3D video system. We may benefit from a common existing video equipment like the one provided for example for scanning the speed limits road signs.

According to one aspect, the imager comprises a lidar with a laser emitting light in the range of 700 nm to 2000 nm, more preferably in the range 1400-1600, and in a particular embodiment about 1550 nanometer. Thereby the system is optimized regarding human eye safety; further, this bandwidth implies low interference with sun spectrum.

According to one aspect, the imager is configured to measure directly relative speeds associated with the point cloud of the second frame. Registration process can be done with the help of the native speed/velocity as per the radar frame registration. One can use for example a special lidar known as a FMCW Lidar as it will be set forth later.

According to one aspect, the speed of each second point is determined indirectly by comparing at least two successive second point cloud frames, either lidar or 3D video. Namely, the imager is configured to measure indirectly relative speeds associated with a subset of the second frame (12), wherein the subset of points is associated with another second frame captured by the imager at a different time. Thereby we may use a lidar scanner which is found readily available and cost-effective on the market, and a low level software loop can compute easily the speed of each second point. Same applies for 3D video since often there is already provided some video equipment for example for scanning the speed limits road signs.

According to one aspect, the radar and imager exhibit different frame rates. Each scanner unit can therefore work optimally, at its most efficient rate, independently from the other one.

According to one aspect, the radar and imager units are spaced from one another. Thanks to the independent and asynchronous registration process promoted therein, there is no need to locate the two scanners at the same position on the vehicle. One can imagine having a radar unit and an imager unit at different positions or at least having different focal points. The radar and the imager units can be substantially far away from one another, let's say more than 1 m. Also this allows great flexibility for integration of scanner in the vehicle architecture.

According to one aspect, the radar and imager units have known and fixed relative positions. This can reduce the time needed to find a match in the registration process from a newly received frame down to the rolling 3D map. For example, the domain to search for registration can be restricted in size, thereby speeding up the registration process.

According to one aspect, the radar and imager units have unknown relative positions, and a calibration process can be performed. Calibration can be obtained after registration of the frame(s) of one device in comparison with the registration of the frame(s) of the other device.

According to one aspect, the radar and imager units have positions that can change over time, for example in case of maintenance (disassembly and then re-assembly) or in case of shock (mechanical deformation of structural support) or for any other reason. As already exposed, registration can take place even though relative positions are not known or has undergone a change. Further, re-calibration, if needed, can be obtained after one or several registrations of the frames of one device in comparison with the registration of the frames of the other device.

According to one aspect, the system is deprived of common clock, i.e. at least radar and imager units have no common clock. The radar and the imager units operate independently and asynchronously, without sharing any time data. Each unit work at its own pace, they have different sampling frequencies. In the promoted system here, there is no need to synchronize various components or subsystems, unlike of the solutions known in the prior art.

According to one aspect, the radar and imager units are mounted on a mobile entity and move along a trajectory. The mobile entity can be typically a vehicle. The promoted solution turns out to be particularly efficient regarding the problem to construct/build quickly and reliably a rolling map in a changing environment. The mobile entity can also be a robot, a drone, an UAV, or the like.

According to another aspect, the radar and imager units are fixedly mounted (i.e. stationary) and the system is configured to detect an intrusion of an object into a protected space/volume. For monitoring protected volumes, the use of velocity is of particular interest to avoid any false positive detection of intrusion. From another standpoint, a true positive alarm can be issued even with a very small object intrudes in the protected volume. Reaction time can also be decreased, using directly speed detection.

According to one aspect, the rolling map of the scene is built in a cumulative and incremental manner. The rolling map starts void and then first point cloud frame is added, and then all the following frames are added incrementally after registration (i.e. matching geometrical transformation function). It may be provided that the most recent points additions are given more weight than the more ancient. Also, in the incremental rolling map, for the same space direction of closer object supersedes a farther object whenever the closer object interposes between the scanner units and the farther object.

According to one aspect, since the computing unit (6) comprises a clock and first and second frames are timestamped, the rolling map can comprise as an attribute for each point the last updated timestamp, which is indicative of the recentness of the information.

According to one aspect, the registration process includes a calculation of a position of a reference point (51a,52a) of the radar or the imager within the map of the scene, this reference point can also be called the ‘pose’. Thereby, the timestamp trajectory of the reference point (pose) of each of first and second scanner units can be reconstructed, slightly a posteriori. Also a trajectory of a further reference point, attached to the vehicle on which are mounted the radar and the imager can also be constructed.

According to one aspect, the system may comprise further radar/imager units (53,54), either radar scanners and/or lidar/3D video devices. The acquisition and registration of frames from further units can also be taken into account with the process exposed above.

According to one aspect, the computing unit (6) is configured to change relative speeds into absolute speeds by subtracting the current speed of the mobile entity on which the scanner units are mounted. Thereby, whenever the radar and imager units are placed on a mobile platform (mobile robot, vehicle, drone, . . . ) the current speed of the platform is subtracted from the relative speed acquired in the point cloud frames, such that the rolling 3D map exhibits as attribute an absolute speed, and not a relative speed, for the points having a speed attribute. Null absolute speeds denote fixed objects like posts, trees, street furniture. Entities having absolute speed different from null speed can be observed with a particular interest.

According to one aspect, the computing unit (6) is coupled to the radar and imager units, through a wired link or wireless link.

According to one aspect, the radar acquires/collects first point cloud frames (11) of the scene with a first filed-of-view, the imager acquires/collects second point cloud frames (12) of the scene with a second filed-of-view. First and second filed-of-views may have different sizes, though it does not preclude effective operation of the registration process exposed above.

Further, the present disclosure is also directed to any vehicle, robot, drone or the like comprising a sensory system as described above.

According to another aspect, the present disclosure is also directed at a method carried out in a system comprising:
a radar configured to generate at least a first frame comprising a first point cloud and first relative speeds,
an imager configured to generate at least a second frame formed as an image and comprising a second point cloud and second relative speeds,
a computing unit (6), and a memory configured to store a map (1), the method comprising :
acquire/collect, at the radar, first point cloud frames (11) of a scene, each first point cloud frame comprising an array of first points, each point having as attribute a position and relative speed with regard to the radar,
at the radar unit, transmit each first point cloud frame to the computing unit as soon as they are available,
acquire/collect, at the imager , second point cloud frames (12) of the scene, each second point cloud frame comprising an array of second points, each point having as attribute at least a 3D position and possibly a relative speed with regard to the second scanner unit,
at the imager, transmit each second point cloud frame to the computing unit as soon as they are available,
at the computing unit, from each of first and second point cloud frames (11,12), perform a registration step where a geometrical transformation function (TR) causes a point cloud frame of interest to match into the rolling map of the scene, wherein speed data is used to register a newly received frame into the current rolling map of the scene,
at the computing unit, update already existing points and/or create new points in the rolling map of the scene (1), where said rolling map of the scene includes not only a position but also a speed of at least a plurality of points,
update continuously and incrementally, at the a computing unit, the rolling map of the scene (1) from the successive registration of data from the first and second point cloud frames (11,12).

According to one aspect, the reception and registration of data from the first and second point cloud frames (11,12) are performed asynchronously, with frame rate and frame resolution being different for first and second point cloud frames.

According to one aspect, the computing unit (6) is configured to change relative speeds into absolute speeds by subtracting the current speed of the mobile entity on which the radar and imager units are mounted.

According to one aspect, the radar and imager units exhibit different frame rates, and the system is deprived of common clock, i.e. at least first and second scanner units have no common clock.

### BRIEF DESCRIPTION OF THE DRAWINGS

Other features and advantages of the invention appear from the following detailed description of two of its embodiments, given by way of non-limiting example, and with reference to the accompanying drawings, in which:

FIG. 1 illustrates a diagrammatical top view of one or more vehicle(s) circulating on a road,

FIG. 2 illustrates a diagrammatical elevation view of the vehicle of interest circulating on a road,

FIG. 3 shows a diagrammatical block diagram of the system promoted in the present disclosure,

FIG. 4 is a chart illustrating the frame collection basic process by a radar scanner unit,

FIG. 5 is a chart illustrating the frame collection basic process by a lidar scanner unit,

FIG. 6 is a time chart illustrating reception of point cloud frames and extraction of data to update the rolling map

FIG. 7 is logic chart illustrating acquisition of point cloud frames and extraction of data to update/increment the rolling 3D map,

FIG. 8 illustrates a data array representing a point cloud frame,

FIG. 9 illustrates an evolution over time of the data rolling 3D map the collected radar and lidar frames,

FIG. 10 illustrates a matrix calculation taking a point cloud frame and updating therefrom the rolling 3D map,

FIGS. 11A and 11B illustrate respectively first and second point cloud frames, exhibiting relative speeds,

FIG. 12 illustrates an example of first and second field of view, and relative velocity vector of a target object.

### DETAILED DESCRIPTION OF THE DISCLOSURE

In the figures, the same references denote identical or similar elements. For sake of clarity, various elements may not be represented at scale.

General Context

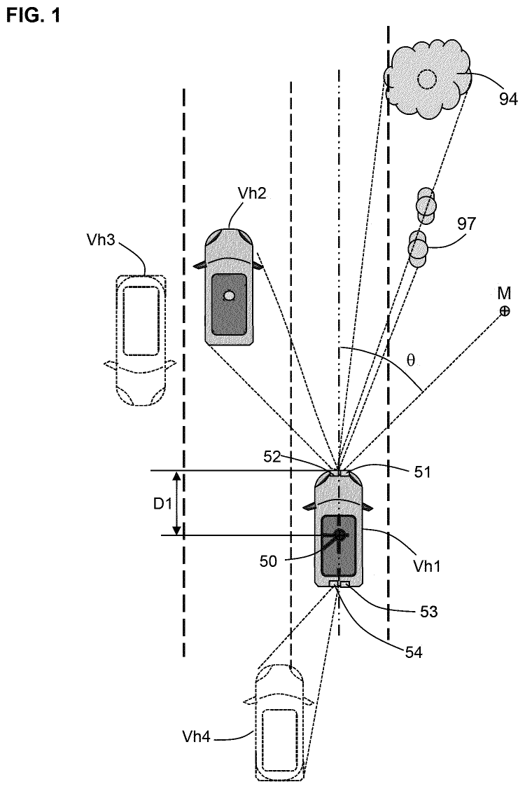

FIG. 1 shows diagrammatically a top view of a road where several vehicles are moving.

The first vehicle denoted Vh1 is of particular interest, since it is equipped with at least two environment sensing units. The second vehicle denoted Vh2 moves in the same direction as per Vh1.

A third vehicle denoted Vh3 moves in the opposite direction as per Vh1. A fourth vehicle denoted Vh4 moves in the same direction as per Vh1, behind Vh1. Additionally, there may be among other things : road/traffic signs on the side of the road or above the road, trees, bushes, etc..

Besides fixed entities, there may be also possibly moving entities likes animals, people, trash bins, objects blown by the wind, etc..

Besides, it is to be considered any kind of users of the road like bicycles, scooters, motorcycles, trucks, buses, vehicles with trailers, not to mention also pedestrians 97. Some of them are moving while others can be stationary either at the side of the road or on traffic lane.

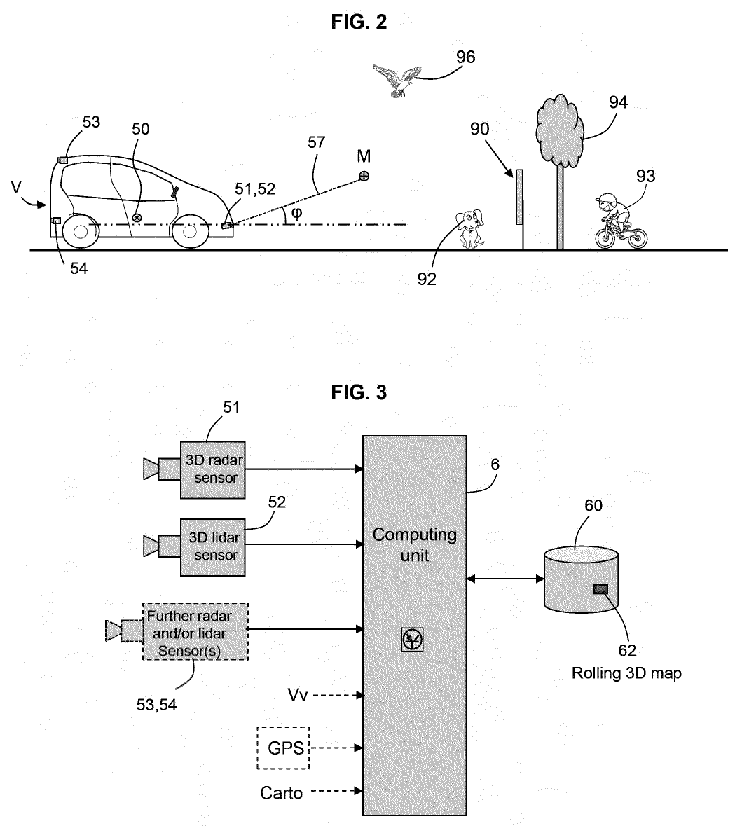

Just to give some illustrative examples with reference to FIG. 2, we consider the cases of a stray dog 92, a flying bird 96, a tree 94, a cycling kid 93. There may be provided as well one or more road sign 90.

The vehicle of interest Vh1 travels in an environment also named the ‘scene’.

Some objects or entities present in the scene may serve as landmarks for the mapping process to be detailed later on.

Radar-Type Unit

With reference to FIG. 3, the system involves a first scanner unit, or first scanner, referenced by 51. The first scanner unit 51 is here a radar-type scanner, simply ‘radar’ in short. The radar 51 uses bursts of electromagnetic waves and echoes coming back from objects present in the scene. As known per se, time difference between transmitting burst instant and backscatter echo reception is proportional to the distance separating the radar from the surface of an object were the electromagnetic waves have bounced back. Either a time difference or an equivalent frequency deviation (FMCW Chirp radar variant) is measured to infer the distance.

The electromagnetic waves used for radar unit 51 have a carrier frequency comprised between 10 MHz and 100 GHz. In one embodiment, the radar unit 51 is a 77 GHz radar scanner. In one embodiment, the radar unit is a 24 GHz radar scanner.

The radar unit 51 exhibits a first field of view denoted FOV1.

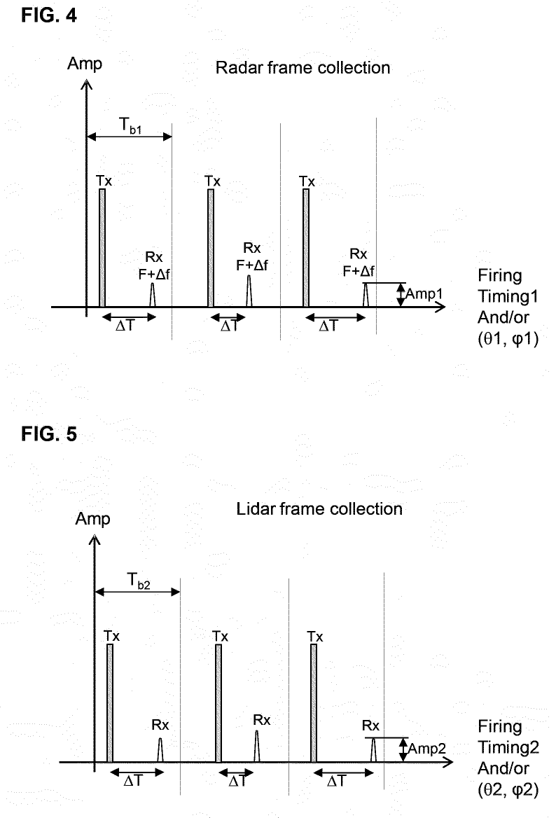

FIG. 4 illustrates the frame collection process at the radar unit 51.

Basically, the example shows a conventional Doppler effect radar device. A burst of electromagnetic waves (Tx) at a carrier frequency F is sent (fired) in a direction of space, via controllable mirrors which orientate the burst according to angles θ1, φ1. Said electromagnetic waves impinge on objects present in the scene, generating echoes. One part of these echoed electromagnetic waves comes back on the same space direction and is received at the radar device.

Three physical characteristics of this process are of particular interest :
firstly, the Doppler frequency shift Δf, which reflects the radial relative velocity of the echoing object with regard to the scanner,
secondly, the time difference ΔT which reflects the time to flight back and forth between the scanner and the echoing object,
thirdly, the amplitude Ampl of the received echoed signal

The scanning processes performed in real-time, i.e., the controllable mirrors are rotated in the space (θ, φ) simultaneously with the firing of burst of electromagnetic waves (Tx) θ1, φ1, to scan the field a view, FOV1=from (θ1min, φ1min) to (θ1max, φ1max). θ can be scanned faster than φ horizontal scanning lines, or θ can be scanned faster than y vertical scanning lines. Firing period is denoted Tb1.

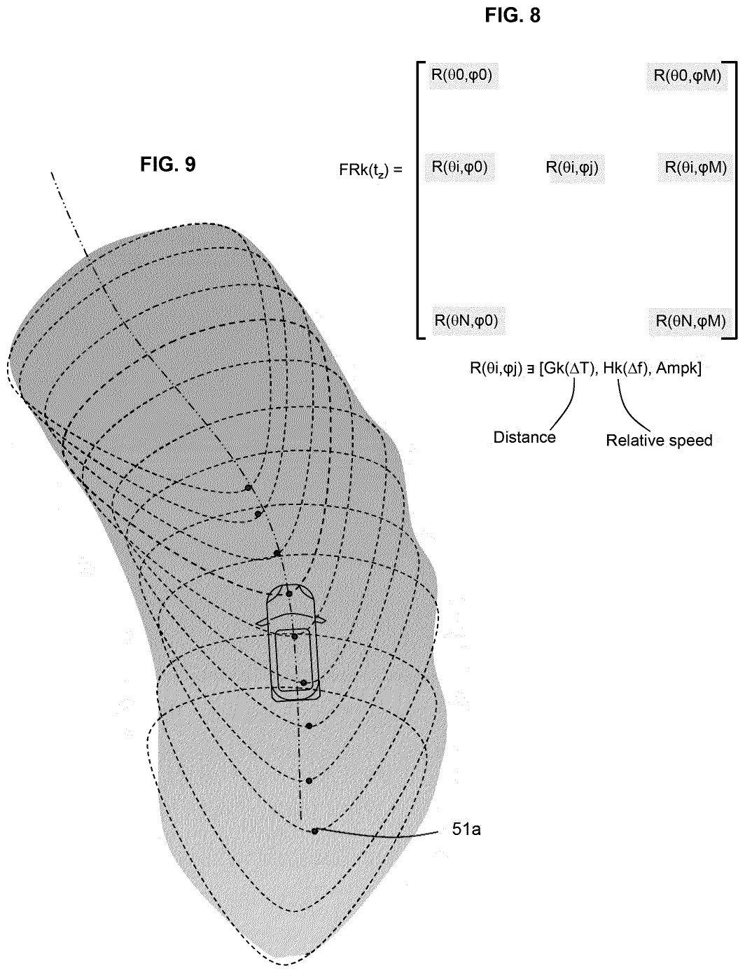

As soon as all the field of view FOV1 has been scanned, the first scanner unit issues a point cloud frame represented at FIG. 8 by a meta-matrix FR1(t_{z}), t_{z} being considered as a sampling time.

Each matrix item R(θi,φj) comprises : [Gk(ΔT), Hk(Δf), Ampk].

The meta-matrix FR1(t_{z}) is also called a tensor.

Gk(ΔT) is representative of the distance separating the echoing target object from the first scanner unit 51. For example Dist=ΔT/2c. where c is wave velocity.

Hk(Δf) is representative of a relative speed. Practically, Hk(Δf) reflects the “radial” relative speed, namely a projection of the relative speed vector on a radius line 57 extending between the sensing device 51,52 and the target point M.

Tangential speed can also be determined if several first frames are compared, or via another method. Ampk is the amplitude of the received echoed signal.

In a simplified variant, the radar unit 51 can be a 2D scan radar device instead of a 3D, for example with a horizontal scanning with large vertical aperture.

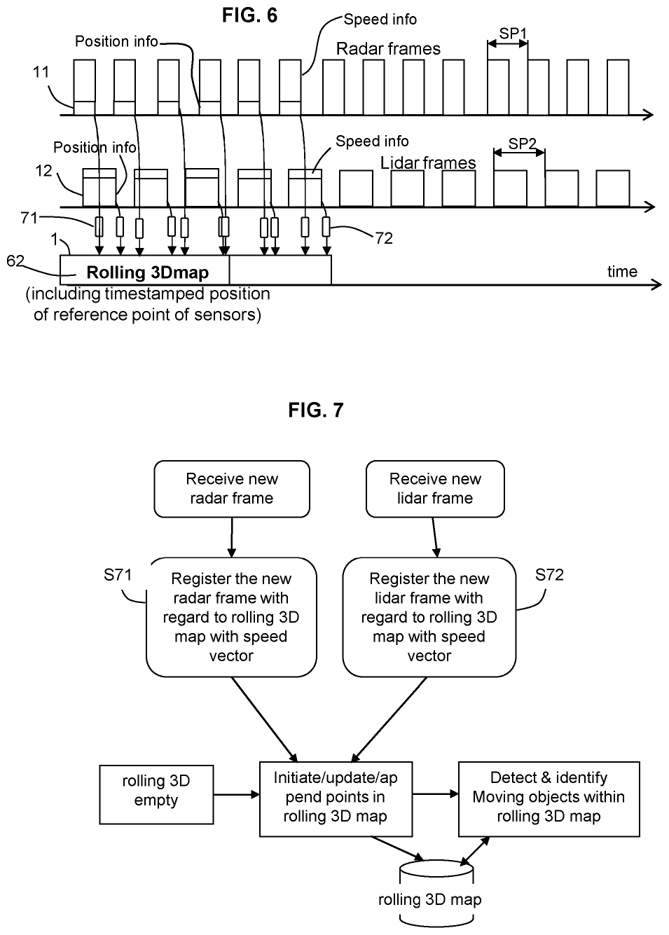

In summary, the first sensing unit (i.e. radar) acquires (collects) first point cloud frames 11 of the scene with the first filed-of-view, each first point cloud frame comprising an array/matrix FR1(t_{z}) of first points, each point having as attribute a position and relative speed with regard to the first sensing unit. Point cloud frame scanning period is denoted SP1 and shown at FIG. 6.

Besides, we define for the radar unit 51 a reference point 51a . Said reference point 51a can be the optics base point, for example the geo center of the rotating mirror systems. Said reference point may also be called ‘pose’.

Lidar-Type Scanner Unit

With reference to FIG. 3, the system involves a second sensing unit, named generically an ‘imager’, referenced by 52. In the shown example, the imager unit 52 is a lidar-type scanner. The imager unit 52 uses bursts of electromagnetic waves and echoes coming back from objects present in the scene. Generally speaking, the imager unit 52 may for instance be a laser rangefinder such as a light detection and ranging (LIDAR) which emits an initial physical signal and receives a reflected physical signal along controlled direction of the local coordinate system. The emitted and reflected physical signals can be for instance light beams, electromagnetic waves having a wavelength comprised between 600 nanometer and 2000 nanometer.

The imager unit 52 computes a range, corresponding to a distance from the imager 52 to a point M of reflection of the initial signal on a surface of an object located in the scene. Said range is computed by comparing the timings features of respective transmitted signal and reflected signal, for instance by comparing the time or the phases of emission and reception.

The imager unit 52 exhibits a second field of view denoted FOV2.

In one example, the imager unit 52 comprises a laser emitting light pulses with a constant time rate, said light pulses being deflected by a two moving mirrors rotating θ2, φ2 along two respective directions.

FIG. 5 illustrates the frame collection process at the imager unit 52.

Basically, in a basic time-of-flight Lidar, a burst of electromagnetic waves (Tx) at a wavelength λ is sent (fired) in a direction of space, via controllable mirrors which orientate the burst according to angles θ2, φ2. Said electromagnetic waves impinge on objects present in the scene, generating echoes. One part of these echoed electromagnetic waves comes back on the same space direction and is received at the radar device.

Two physical characteristics of this process are of particular interest :
firstly, the time difference AT which reflects the time to flight back and forth between the scanner and the echoing object,
secondly, the amplitude Amp2 of the received echoed signal,

The scanning processes performed in real-time, i.e., the controllable mirrors are rotated in the space (θ, φ) simultaneously with the firing of burst of electromagnetic waves (Tx) θ2, φ2, two scan the field a view, FOV2=from θ2min, φ2min to θ2max, φ2max.

Firing period is denoted Tb2. Generally, Tb2 is different from Tb1.

As soon as all the field of view FOV2 has been scanned, the first scanner unit issues a point cloud frame represented at FIG. 8 by a matrix FR2(t_{z}), t_{z} being considered as a sampling time.

Each matrix item R(θi,φj) comprises [Gk(ΔT), Ampk], as represented at FIG. 8.

Gk(ΔT) is representative of the distance separating the echoing target object from the imager unit 52. For example Dist=ΔT/2c. Ampk is the amplitude of the received echoed signal.

Additionally, speed of points in the point cloud frame FR2(t_{z}), can be computed from the difference position between two successively collected point cloud frame [FR2(t_{z-1}) FR2(t_{z})].

Alternatively the imager can be configured to measure indirectly relative speeds associated with a subset of the second frame (12), wherein the subset of points is associated with another second frame captured by the imager at a different time.

In one embodiment, the imager unit 52 is 1500 nanometer Lidar.

In another embodiment, the imager unit 52 is 1550 nanometer Lidar.

In one variant embodiment, the imager unit 52 is a FMCW type Lidar. According to this variant, wavelength ramps are generated in the transmitted electromagnetic waves. Echoes coming back from the surface of objects in the scene exhibit therefore frequency/wavelength different from the currently transmitted frequency/wavelength. However a small doppler shift is added if the target object has an radial relative speed. This difference is converted into a time delay at first order, but also the doppler shift is converted into a radial relative speed. U.S. Pat. No. 7,986,397 gives a practical example of a Doppler Lidar.

In summary, the imager unit 52 acquires (collects) second point cloud frames 12 of the scene with the second filed-of-view, each second point cloud frame comprising an array/matrix FR2(t_{z′}) of second points, each point having as attribute at least a 3D position. Additionally an optionally each second point may as attribute a relative speed with regard to the second scanner unit. Point cloud frame scanning period is denoted SP2 and shown at FIG. 6.

Besides, we define for the lidar unit 52 a reference point 52a . Said reference point 52a can be the optics focal base point of the imager unit. Said reference point may be called ‘pose’.

First and second fields of view FOV1, FOV2 may be different in size namely, regarding their width and height. It does not preclude the registration process to work for any point cloud frame received at the computing unit 6.

As an alternative to lidar, one can use stereo vision system to generate second frames. For example, with two video cameras situated away from each other, and with triangulation techniques, it is possible to build a 3D image across the second field of view FOV2.

Computing System Overview

As shown at FIG. 3, there is provided a computing unit denoted 6 which is coupled to the radar unit 51 and the imager unit 52.

In the shown example, the computing unit 6 is distinct from radar and imager 51,52. Alternatively, the computing unit 6 could be arranged next to the first scanner 51 or next to the imager 52, or even integrated within one of them.

There is provided a data storage space 60 where the computing unit is able to store the rolling 3D map 62 of the scene. The data storage space can be integrated in the computing unit 6 or distinct from the computing unit.

Without being an essential feature, the computing unit can receive the current vehicle speed Vv from another on-board unit of the vehicle of interest Vh1.

Similarly, without being an essential feature, the computing unit can receive a current geolocation (GPS) from another on-board unit of the vehicle of interest Vh1.

Similarly, without being an essential feature, there may be available at the computing unit a cartographic map (Carto), as known in the navigation systems.

Besides, the computing unit 6 comprises a clock for generating timestamps. The clock of the computing unit may be synchronized with an absolute clock like an UTC clock. In one embodiment, the computing unit 6 receives clock update and/or clock synchronization signal from a remote entity through an Internet enabled communication link.

As stated above, the first sensing unit acquires (collects) first point cloud frames 11 of the scene with the first filed-of-view FOV1, each first point cloud frame comprising an array of first points, each point having as attribute a position and relative speed with regard to the first scanner unit. In addition, the radar unit 51 transmits each first point cloud frame 11 to the computing unit 6 as soon as they are available, such that the first point cloud frame 11 can be registered into the rolling 3D map 62.

As stated above, the second sensing unit acquires (collects) second point cloud frames 12 of the scene with the second filed-of-view, each second point cloud frame comprising an array of second points, each point having as attribute a position (and possibly relative speed) with regard to the imager unit. In addition, the imager unit 52 transmits each second point cloud frame 12 to the computing unit 6 as soon as they are available, such that the second point cloud frame 12 can be registered into the rolling 3D map 62.

The above process is illustrated at FIGS. 6 and 7. Each time a point cloud frame, 11,12 irrespective of first and second, it is transmitted immediately to a registration process block.

Registration process block is denoted 71, S71 for first point cloud frames 11. Registration process block is denoted 72, S72 for second point cloud frames 12.

Registration process is performed asynchronously. The rolling 3D map 62 is built gradually, progressively, incrementally.

Each of first frames 11 and second frames 12 are registered independently and asynchronously, as soon as it is made available. Velocity resolution/accuracy is higher than position resolution in first point cloud frames 11, whereas distance/position resolution is higher than velocity resolution/accuracy in second point cloud frames 12, as depicted graphically by the size of rectangles at the top two timelines of FIG. 6.

The second point cloud frames 12 have generally a better spatial resolution than the first point cloud frames 11. Advantageously, it may be considered that a 2D grid is created from the second point cloud frames 12, and the first point cloud frames 11 are registered into said grid as it will be explained below.

In addition, there may be provided a selection of points using a weighting function, such as making points that are further away weigh less than close ones.

Registration and Implementation of Rolling 3D Map

Registration process involves a geometrical transformation function TR cause a point cloud frame of interest to match into the rolling map of the scene.

The registration process causes the point cloud frame of interest (the latest received) to find the best possible match into the rolling 3D map of the scene, which implies mathematical transformation(s) to shift, orientate, spread-in spread-out the array of points of the point cloud frame of interest.

Find the best possible match into the rolling 3D map can be done by scanning transformation noted TRi, and searching from the best match with an interactive closest points process [TRi]×[FRn(k)] to be compared to portions of [RMAP(tk)] (full rolling 3D map).

Of course, the search may be started from the last registration positions regarding the same sensing source (either the radar or the lidar, or further sensing devices).

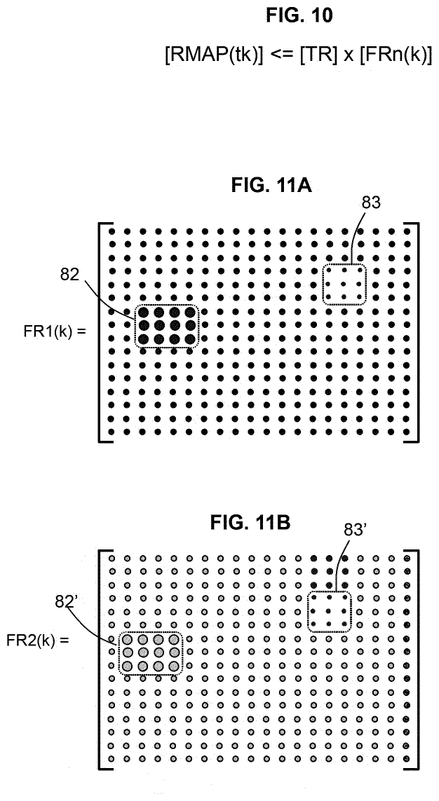

Such geometrical transformation function is illustrated at FIG. 10.

In the context of the present disclosure, speed data is used to register a newly received frame into the current rolling map of the scene. Namely, the closeness between [RMAP(tk)] and [TRi]×[FRn(k)] is evaluated from the velocity of the respective points.

Once the best match TRi=TR_{best} is found, the relevant data [TR_{best}]×[FRn(k)] imported into the rolling 3D map 62, which is summarised in FIG. 10 by the symbolic formula:

[RMAP(tk)]<=[TR]×[FRn(k)].

TR is a tensor-to-tensor transform or a tensor-to-matrix transform.

One example of general registration technique can be found in document EP3078935.

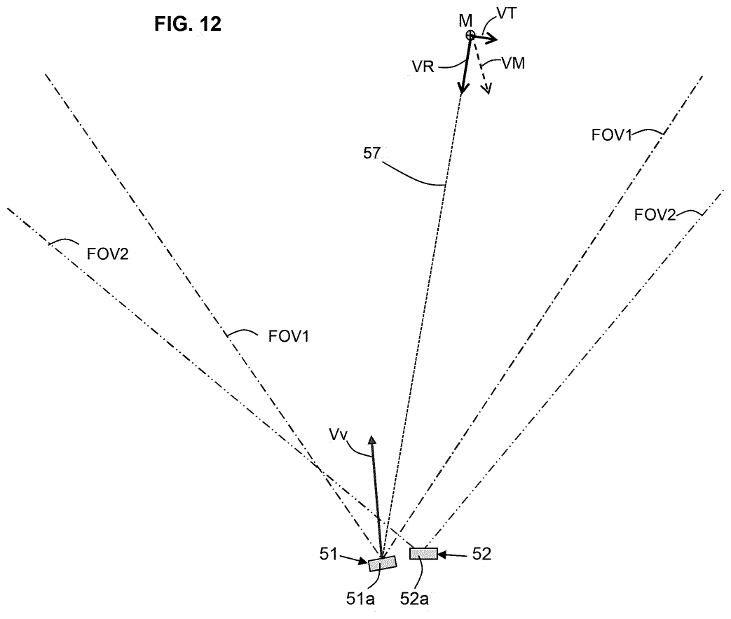

FIG. 12 illustrates a speed vector decomposition for target object having a surface providing a backscattering echo. The relative vector of the object denoted VM is decomposed radial speed component denoted VM along the radius line 57 already mentioned and a tangential speed component denoted VT. Here the tangential speed component is illustrated in the horizontal plane however they may be also component in the vertical plane (not shown).

On the other hand, with reference to the radar unit 51, the radar unit is moving with the same speed Vv as the vehicle on which it is mounted.

In a typical example where the radar and imager units are placed on a mobile platform (mobile robot, vehicle, drone, . . . ) the current speed of the platform Vv is subtracted from the relative speed VM acquired in the point cloud frames. Thereby, the rolling 3D map exhibits as attribute an absolute speed, and not a relative, for the points having a speed attribute.

Null absolute speeds denote fixed objects like posts, trees, street furniture.

We also note also from FIG. 12 that the reference point 51a of the radar unit 51 can be located at a distance from the reference point 52a of the the imager unit 52. This does not preclude the registration process exposed above to operate properly.

Also, as apparent from FIGS. 1 and 2, there may be defined one or more particular point of interest 50 belonging to the vehicle like its centre of gravity or its normal centre of gyration. The geometrical offset D1 separating the reference point (51a,52a) can be compensated for in the software for controlling the vehicle.

On FIGS. 11A and 11B, the size of each of the bullet-points represents the relative radial speed of target objects in the scene. In the first point cloud frames FR1(k),the background is stationary, the size of the bullet-points are medium. 82 denotes an object getting closer to the scanner unit, for example Vh3 on FIG. 1, the size of the bullet points is larger. 83 denotes an object moving in the same direction as per the scanner unit, for example Vh2 on FIG. 1, the size of the bullet points is smaller.

Translated into absolute speeds, having defined an axis opposite to the vehicle displacement, 82 exhibits a positive radial speed whereas 83 exhibits a negative radial speed.

Second point cloud frame FR2(k) also exhibit similar areas 82′, 83′. Such peculiar areas 82′, 83′ are not necessarily at the same position than corresponding peculiar areas 82, 83 of first frame FR1(k), given possible difference in field of view, resolution, point-of-view reference point, etc..

The registration process exposed above, thanks to the confirmation, causes coincidence of areas 82 and 82′ with corresponding area in the stored rolling map, and causes coincidence of areas 83 and 83′ with corresponding area in the stored rolling map.

As illustrated at FIG. 9, tracking of reference points 51a, 52a is carried out from registration process. Each time a new frame is register the rolling map the new reference point 51a (respectively 52a) is compared to the previously recorded reference point 51a . A segment extending from the previous position to the new position represents the displacement of the sensor and therefore the displacement of the vehicle. We obtained therefrom a trajectory construction of vehicle within the rolling map.

In some embodiments, this trajectory construction can be confirmed and/or refined by the GPS tracking points.

Miscellaneous

The promoted method and system work with a GPS-deprived environment (tunnels, multi story parking lots, . . . ), or in places with poor GPS accuracy (mountain roads, . . . ).

Each frame, namely first and second frames, is timestamped. The timestamping can occur at reception at the computing unit 6. Likewise, preferably time stamping can be carried out locally at each environment sensing unit namely radar 51 and imager 52. There may be provided a synchronization of local clocks at radar 51 and imager 52, with regard to a ‘master’ clock arranged at the computing unit 6.

The system may comprise further radar/imager units 53,54, either radar scanners and/or lidar/3D video devices. The acquisition and registration of frames from further units can also be taken into account with the incremental process for building map as exposed above.

There may be a limit to the depth of the first and second rolling maps, due to memory and processing constraints. Each rolling map can contain several thousands points for example. A way to keep the more interesting points can be a proximity criterion rather than a recentness criterion, i.e. we keep points that are located at a distance below a certain threshold. However, points belonging to an assumed moving object can also be retained in the rolling map even though there are at a distance above the threshold.

Typical frame rate for radar 51 is comprised between 10 Hz and 30 Hz, it can be around 20 Hz. Angular resolution for the radar unit 51 can typically be comprised between 0.5° and 1.5°, although other resolution is not excluded.

Typical frame rate for imager 52 is comprised between 10 Hz and 30 Hz, it can be around 20 Hz. Angular resolution for the imager unit like a Lidar can typically be comprised between 0.05° and 0.5°, although other resolution is not excluded.

We note that first frame scanning period SP1 is different from second frame scanning period SP2.

1. A system comprising:
a radar configured to generate at least a first frame comprising a first point cloud and first relative speeds,
an imager configured to generate at least a second frame formed as an image and comprising a second point cloud and second relative speeds,
at least a clock configured to generate first and second timestamps associated to the first frame and second frame respectively,
a memory configured to store a map,
a computing unit configured to update the map with a registration of the first point cloud data of the first frame using the first timestamp and the first relative speeds, speed data being used to register a newly received first frame, and further configured to update the map with a registration of the second point cloud data of the second frame using the second timestamp and the relative speeds associated with the second frame, speed data being used to register a newly received second frame.

2. The system according to claim 1, wherein the imager comprises a lidar-type sensor or a stereo-imaging device.

3. The system according to claim 1, wherein the imager comprises a lidar with a laser emitting light in the range of 700 nm to 2000 nm.

4. The system according to claim 3, wherein the imager is configured to measure directly relative and/or radial speeds associated with the point cloud of the second frame.

5. The system according to claim 3, wherein the imager is configured to measure indirectly relative speeds associated with a subset of points of the point cloud of the second frame, wherein the subset of points is associated with another second frame captured by the imager at a different time.

6. The system according to claim 1, wherein the radar and the imager exhibit different frame rates.

7. The system according to claim 1, wherein the radar and the imager are mounted on a mobile entity and move along a trajectory.

8. The system according to claim 1, wherein the radar and imager are fixedly mounted and the system is configured to detect an intrusion of an object into a protected space/volume.

9. The system according to claim 1, wherein the registration includes a calculation of a position of a reference point of the radar or the imager within the map.

10. The system according to claim 1, wherein the computing unit is configured to change relative speeds into absolute speeds by subtracting the current speed of the mobile entity on which the radar and imager units are mounted.

11. A vehicle comprising a system according to claim 1.

12. A method carried out in a system comprising
a radar configured to generate at least a first frame comprising a first point cloud and first relative speeds,
an imager configured to generate at least a second frame formed as an image and comprising a second point cloud and second relative speeds,
a computing unit, and a memory configured to store a map, the method comprising:
acquiring/collecting, at the radar, first point cloud frames of a scene, each first point cloud frame comprising an array of first points, each point having as attribute a position and relative speed with regard to the radar,
at the radar unit, transmitting each first point cloud frame to the computing unit as soon as they are available,
acquiring/collecting, at the imager, second point cloud frames of the scene, each second point cloud frame comprising an array of second points, each point having as attribute at least a 3D position,
at the imager, transmit transmitting each second point cloud frame to the computing unit as soon as they are available,
at the computing unit, from each of first and second point cloud frames, performing a registration step where a geometrical transformation function cause a point cloud frame of interest to match into the rolling map of the scene, wherein speed data is used to register a newly received frame into the current rolling map of the scene,
at the computing unit, updating already existing points and/or create new points in the rolling map of the scene, where said rolling map of the scene includes not only a position but also a speed of at least a plurality of points,
updating continuously and incrementally, at the-a computing unit, the rolling map of the scene from the successive registration of data from the first and second point cloud frames.

13. The method according to claim 12, wherein the reception and registration of data from the first and second point cloud frames are performed asynchronously, with frame rate and frame resolution being different for first and second point cloud frames.

14. The method according to claim 12, wherein the computing unit is configured to change relative speeds into absolute speeds by subtracting the current speed of the mobile entity on which the radar and imager units are mounted.

15. The method according to claim 12, wherein the radar and the imager units exhibit different frame rates, and at least the radar and the imager units have no common clock.

16. The method of claim 12, wherein in the step of acquiring/collecting the second point cloud frames, each of the points has as an additional attribute relative speed with regard to the imager.

17. The system according to claim 2, wherein the radar and the imager exhibit different frame rates.

18. The system according to claim 3, wherein the radar and the imager exhibit different frame rates.

19. The system according to claim 4, wherein the radar and the imager exhibit different frame rates.

20. The system according to claim 5, wherein the radar and the imager exhibit different frame rates.
